(19) United States
(12) Patent Application Publication
(10) Pub. No.: US 2026/0228334 A1
(43) Pub. Date: Aug. 6, 2026

(54) PROGRAM ANALYSIS DEVICE, PROGRAM ANALYSIS METHOD, AND RECORDING MEDIUM STORING PROGRAM ANALYSIS PROGRAM

(71) Applicant: NEC Corporation, Tokyo (JP)

(72) Inventors: Daichi ARAI, Tokyo (JP); Kohei TATARA, Tokyo (JP)

(73) Assignee: NEC Corporation, Tokyo (JP)

(21) Appl. No.: 19/151,387

(22) PCT Filed: Feb. 8, 2023
(86) PCT No.: PCT/JP2023/004101

§ 371 Date: Jul. 28, 2025

(51) Int. Cl. G06F 21/56

(52) U.S. Cl. CPC G06F 21/566; G06F 21/562; G06F 2221/033

(57) ABSTRACT

A program analysis device according to an aspect of the present disclosure includes: at least one memory storing instructions; and at least one processor configured to execute the instructions to: identify a transmission function for information included in a first program and a reception function for information included in a second program by performing at least one of static analysis on the first program and the second program and dynamic analysis on an operation of an information processing device that executes both of the first program and the second program; and estimate that the information propagates between the transmission function and the reception function, for which a specification indicated by an identification result regarding the transmission function and the reception function satisfies a predetermined condition.

### TECHNICAL FIELD

The present invention relates to a program analysis device, a program analysis method, and a recording medium storing a program analysis program.

### BACKGROUND ART

In recent years, cyberattacks using malicious programs (malware) are rampant, and society is exposed to threats such as information leakage and system down. In addition, functions of the malicious programs have been diversified and advanced year by year. Therefore, a technique for more suitably detecting such a malicious program is expected.

In relation to such a technology, PTL 1 discloses an identification device that adds a tag to data received by malware upon execution of the malware, the tag capable of uniquely identifying identification information for a transmission source of the data, and tracks propagation of the data added with the tag. The device acquires a tag of data referenced by a branch instruction executed by the malware, among the tracked data. The device analyzes information on an instruction of a branch destination not executed by the malware after the branch instruction. Then, the device identifies identification information of a command server for issuing a command to the malware from the identification information of the transmission source related to the tag acquired, based on the analysis result.

PTL 2 discloses a computer system that executes dynamic analysis for a sample of a malicious program, and outputs an analysis result including a coupling destination to and from which the malicious program communicates. This system detects variation of the coupling destination based on results of cyclic observation of the coupling destination, and outputs a result of the detection. Then, this system stores the analysis result and the result of the detection in a form that allows sharing among a plurality of external computers.

PTL 3 discloses an information processing device that reads a manifest file included in an application program for providing information on the application program to an operation system. This device analyzes a degree of malware of the application program based on use permission information of each function described in the manifest file.

### CITATION LIST

### Patent Literature

PTL 1: WO 2016/093182 A 1

PTL 2: WO 2021/024532 A 1

PTL 3: JP 2013-222422 A

### SUMMARY OF INVENTION

### Technical Problem

An illegal function (backdoor) of a malicious program executes processing outside the authority (for example, processing in which execution authority is given only to an authorized system administrator) by using information that is input from the outside and known only to an attacker. In such detection of the illegal function, for example, a method of tracking a flow in which information input from the outside propagates from a variable to another variable by analyzing a control structure of a program is used. In such a method for detecting the illegal function, since analysis is usually performed in a program, there is a problem that, in tracking of propagation of information input from the outside, when the information reaches an information transmission function that transmits information to another program, subsequent information propagation cannot be tracked.

That is, it is a problem to track information propagation even in a case where the information propagates across a program. PTLs 1 to 3 cannot solve this problem.

A main object of the present invention is to enable information propagation to be tracked even in a case where information propagates across a program.

### Solution to Problem

A program analysis device according to an aspect of the present invention includes: identification means for identifying a transmission function for information included in a first program and a reception function for information included in a second program by performing at least one of static analysis on the first program and the second program and dynamic analysis on an operation of an information processing device that executes both of the first program and the second program; and estimation means for estimating that the information propagates between the transmission function and the reception function, for which a specification indicated by an identification result regarding the transmission function and the reception function satisfies a predetermined condition.

From another point of view for achieving the above-mentioned object, a program analysis method according to an aspect of the present invention includes, by a first information processing device: identifying a transmission function for information included in a first program and a reception function for information included in a second program by performing at least one of static analysis on the first program and the second program and dynamic analysis on an operation of a second information processing device that executes both of the first program and the second program; and estimating that the information propagates between the transmission function and the reception function, for which a specification indicated by an identification result regarding the transmission function and the reception function satisfies a predetermined condition.

From furthermore another point of view for achieving the above-mentioned object, a program analysis program according to an aspect of the present invention causes a computer to execute: an identifying process of identifying a transmission function for information included in a first program and a reception function for information included in a second program by performing at least one of static analysis on the first program and the second program and dynamic analysis on an operation of an information processing device that executes both of the first program and the second program; and an estimation process of estimating that the information propagates between the transmission function and the reception function, for which a specification indicated by an identification result regarding the transmission function and the reception function satisfies a predetermined condition.

In addition, the present invention can also be implemented by a nonvolatile computer-readable recording medium storing the program analysis program (computer program).

### ADVANTAGEOUS EFFECTS OF INVENTION

According to the present invention, even in a case where information propagates across a program, the information propagation can be tracked.

### BRIEF DESCRIPTION OF DRAWINGS

FIG. 1 is a block diagram illustrating a configuration of a program analysis system 1 according to a first example embodiment of the present invention.

FIG. 2 is a diagram illustrating a source code of a program 101 according to the first example embodiment of the present invention.

FIG. 3 is a diagram illustrating a source code of a program 102 according to the first example embodiment of the present invention.

FIG. 4 is a diagram illustrating contents of a static analysis rule 1110 and an information propagation estimation rule 120 in static analysis according to the first example embodiment of the present invention.

FIG. 5 is a diagram illustrating a first example of dynamic analysis by a dynamic analysis unit 112 according to the first example embodiment of the present invention and an operation of an estimation unit 12 based on a result of the dynamic analysis.

FIG. 6 is a diagram illustrating a second example of dynamic analysis by the dynamic analysis unit 112 according to the first example embodiment of the present invention and the operation of the estimation unit 12 based on the result of the dynamic analysis.

FIG. 7 is a diagram illustrating a third example of dynamic analysis by the dynamic analysis unit 112 according to the first example embodiment of the present invention and the operation of the estimation unit 12 based on the result of the dynamic analysis.

FIG. 8 is a flowchart illustrating estimation operation of information propagation across a program by static analysis of the program analysis device 10 according to the first example embodiment of the present invention.

FIG. 9 is a flowchart illustrating estimation operation of information propagation across a program by dynamic analysis of the program analysis device 10 according to the first example embodiment of the present invention.

FIG. 10 is a block diagram illustrating a configuration of a program analysis device 30 according to a second example embodiment of the present invention.

FIG. 11 is a flowchart illustrating an operation of the program analysis device 30 according to the second example embodiment of the present invention.

FIG. 12 is a block diagram illustrating a configuration of an information processing device 900 capable of realizing the program analysis device according to each example embodiment of the present invention.

### EXAMPLE EMBODIMENT

Hereinafter, example embodiments of the present invention will be described in detail with reference to the drawings.

### First Example Embodiment

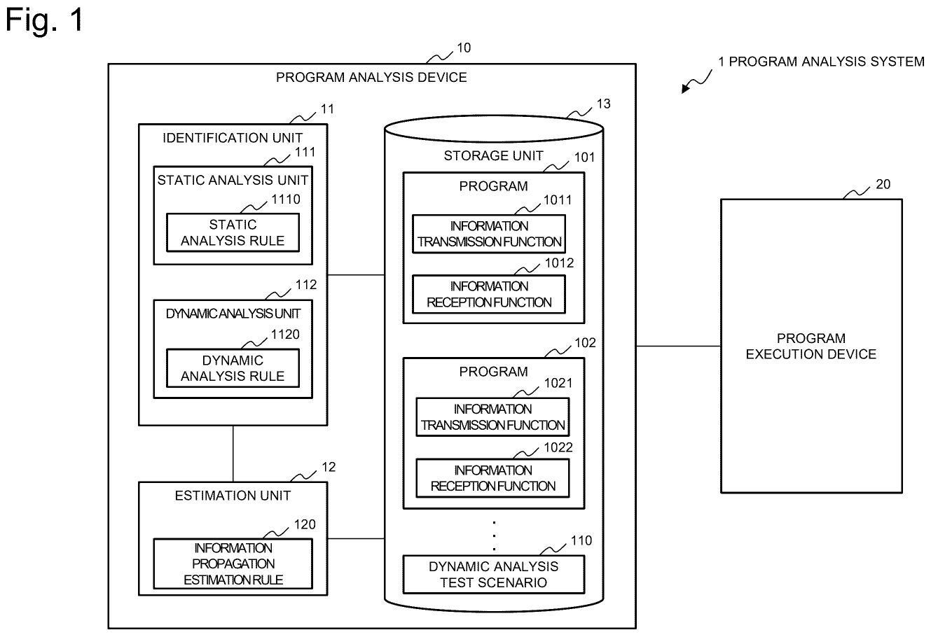

FIG. 1 is a block diagram illustrating a configuration of a program analysis system 1 according to a first example embodiment of the present invention.

The program analysis system 1 roughly includes a program analysis device 10 and a program execution device 20. The program analysis device 10 and the program execution device 20 are communicably connected.

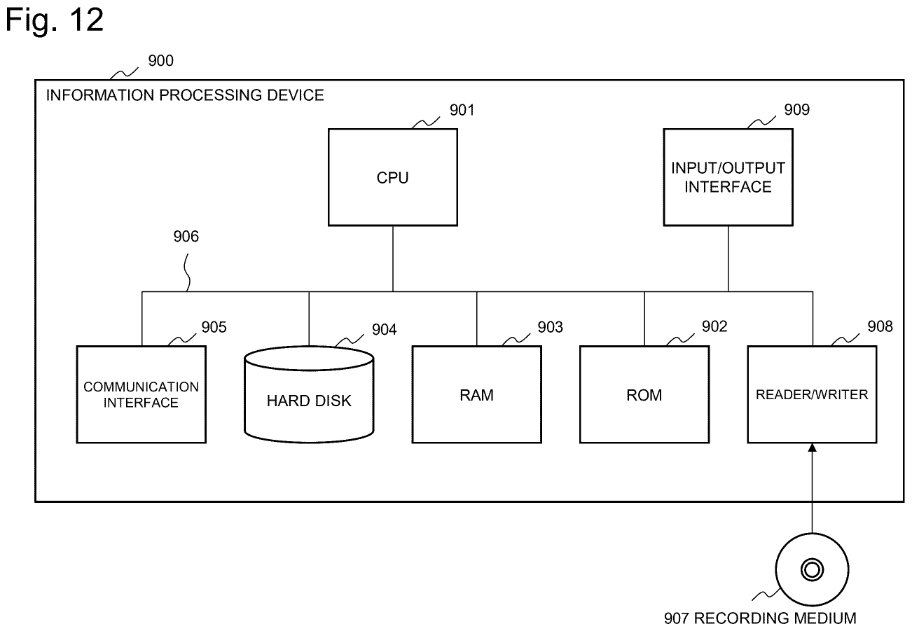

The program execution device 20 is, for example, a device having a configuration similar to that of an information processing device 900 described later with reference to FIG. 12. The program execution device 20 executes a program 101, a program 102, and the like described later. The programs 101 and 102 are specimens for which the program analysis device 10 analyzes information propagation across the program. The program 101 is an example of a first program or a second program. The program 102 is an example of the first program or the second program. The program analysis device 10 and the program execution device 20 may be configured in the same information processing device.

The program analysis device 10 includes an identification unit 11, an estimation unit 12, and a storage unit 13. The identification unit 11 and the estimation unit 12 are examples of identification means and estimation means.

The storage unit 13 is, for example, a storage device such as a RAM (Random Access Memory) or a hard disk 904 described later with reference to FIG. 12. The storage unit 13 stores the program 101, the program 102, and a dynamic analysis test scenario 110. The storage unit 13 may store a program (that is, three or more programs) other than the programs 101 and 102 as an analysis target of the program analysis device 10. The program 101, the program 102, and the dynamic analysis test scenario 110 stored in the storage unit 13 will be described later.

The program analysis device 10 according to the present example embodiment performs at least one of static analysis and dynamic analysis on the programs 101 and 102 to estimate the presence of information propagation between the programs 101 and 102. Hereinafter, with respect to the case of performing static analysis and the case of performing dynamic analysis on the programs 101 and 102, an operation of estimating information propagation across the program by the program analysis device 10 will be sequentially described.

### Estimation Operation Of Information Propagation Across Program By Static Analysis On Program

The program analysis device 10 performs static analysis on source files of the programs 101 and 102 to estimate the presence of information propagation from the program 101 to the program 102 or from the program 102 to the program 101.

A static analysis unit 111 included in the identification unit 11 identifies a transmission function for information to the outside included in the programs 101 and 102 (first program) and a reception function for information from the outside included in the programs 101 and 102 (second program) by performing static analysis on source codes of the programs 101 and 102. More specifically, the static analysis unit 111 performs static analysis on the source code of the program 101 to identify a specification of an information transmission function 1011 and a specification of an information reception function 1012 included in the program 101 based on a static analysis rule 1110. Similarly, the static analysis unit 111 performs static analysis on the source code of the program 102 to identify a specification of an information transmission function 1021 and a specification of an information reception function 1022 included in the program 102 based on the static analysis rule 1110.

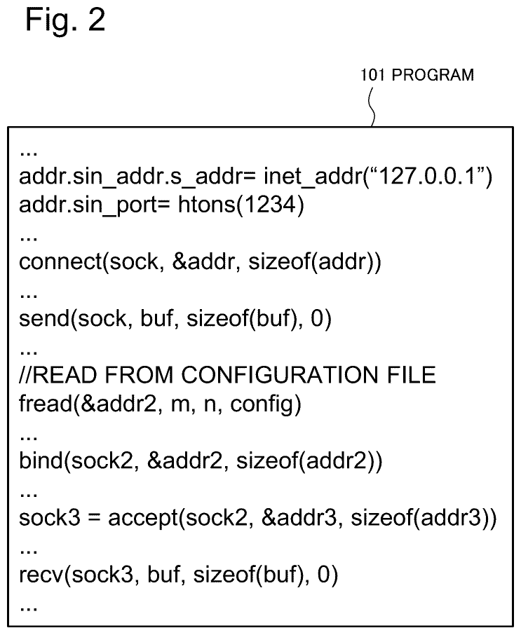

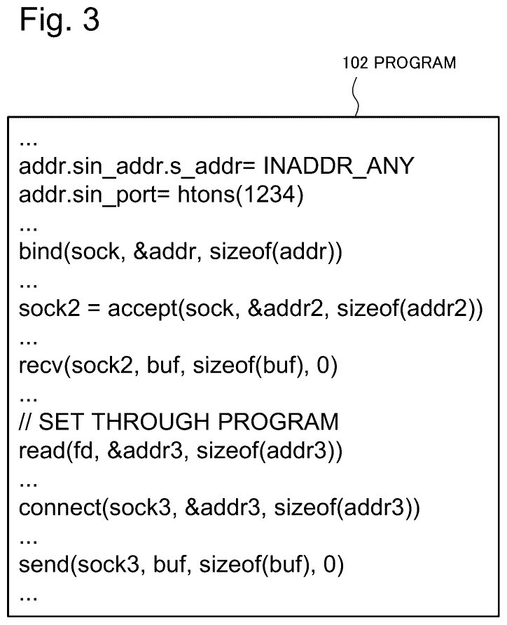

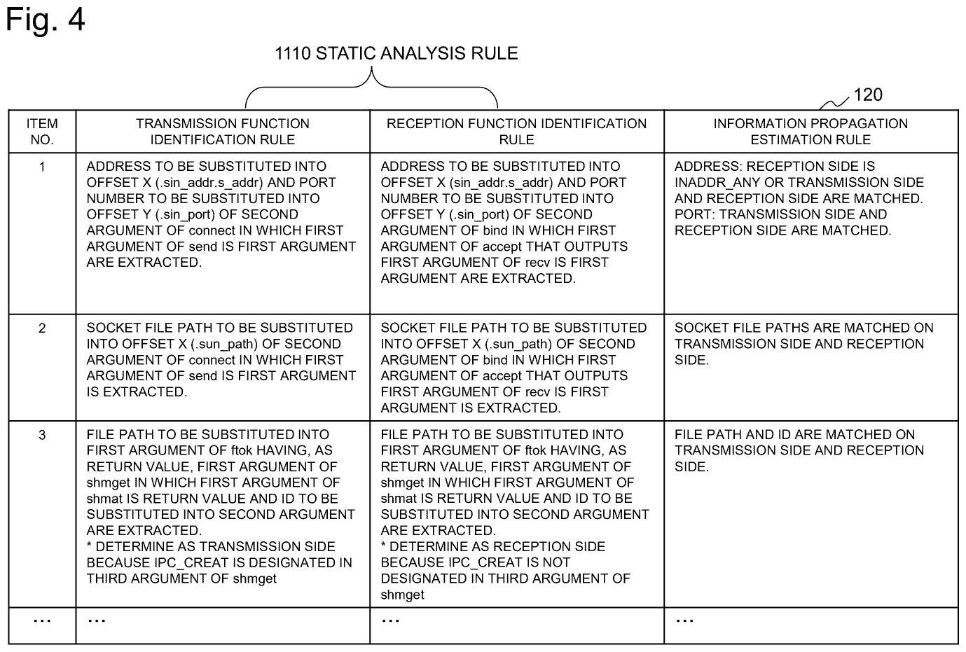

FIG. 2 is a diagram illustrating the source code of the program 101 according to the present example embodiment. FIG. 3 is a diagram illustrating the source code of the program 102 according to the present example embodiment. FIG. 4 is a diagram illustrating contents of the static analysis rule 1110 and an information propagation estimation rule 120 described later in static analysis according to the present example embodiment. More specifically, the static analysis rule 1110 illustrated in FIG. 4 includes a transmission function identification rule and a reception function identification rule. The transmission function identification rule is a rule for identifying the specification of the information transmission function 1011 or 1021. The reception function identification rule is a rule for identifying the specification of the information reception function 1012 or 1022.

Based on the transmission function identification rule of item number 1 illustrated in FIG. 4, the static analysis unit 111 identifies (extracts) that an address to be substituted into an offset X (.sin_addr.s_addr) of a second argument “addr” of “connect” in which “sock” that is a first argument of “send” that is the information transmission function 1011 in the program 101 illustrated in FIG. 2 is a first argument is “inet_addr (“127.0.0.1”)”. The static analysis unit 111 identifies that a port number to be substituted into an offset Y (.sin_port) of the second argument “addr” is “htons (1234)” based on the transmission function identification rule of the item number 1 illustrated in FIG. 4. As described above, the static analysis unit 111 identifies an address and a port related to a transmission destination of information of the information transmission function 1011 as the specification of the information transmission function 1011 included in the program 101.

Based on the reception function identification rule of the item number 1 illustrated in FIG. 4, the static analysis unit 111 identifies that an address to be substituted into the offset X (.sin_addr.s_addr) of the second argument “addr” of “bind” in which the first argument “sock” of “accept” that outputs “sock2” that is a first argument of “recv” that is the information reception function 1022 in the program 102 illustrated in FIG. 3 is a first argument is “INADDR_ANY”. Here, “INADDR_ANY” indicates that any address value may be used. The static analysis unit 111 identifies that the port number to be substituted into the offset Y (.sin_port) of the second argument “addr” is “htons (1234)” based on the reception function identification rule of the item number 1 illustrated in FIG. 4. As described above, the static analysis unit 111 identifies an address and a port related to a reception destination of information of the information reception function 1022 as the specification of the information reception function 1022.

When an identification result by the static analysis unit 111 regarding a transmission function and a reception function for the information included in the program 101 and the program 102 satisfies the information propagation estimation rule 120 (predetermined condition), the estimation unit 12 estimates that the information propagates in a combination of the transmission function and the reception function.

According to the information propagation estimation rule 120 of the item number 1 illustrated in FIG. 4, a condition for estimating that the information propagates between the programs 101 and 102 is that a reception side is “INADDR_ANY” with respect to the address, or a transmission side and the reception side are matched with each other and the transmission side and the reception side are matched with each other with respect to the port. Regarding the program 101 illustrated in FIG. 2 and the program 102 illustrated in FIG. 3, the specifications of the information transmission function 1011 and the information reception function 1022 identified by the static analysis unit 111 satisfy the information propagation estimation rule 120 of the item number 1 illustrated in FIG. 4. Therefore, in this case, the estimation unit 12 estimates that the information propagates from “send” that is the information transmission function 1011 of the program 101 illustrated in FIG. 2 to “recv” that is the information reception function 1022 of the program 102 illustrated in FIG. 3.

Item numbers 2 and 3 illustrated in FIG. 4 represent another example related to the static analysis rule 1110 and the information propagation estimation rule 120. However, in the static analysis rule 1110 and the information propagation estimation rule 120 of the item numbers 2 and 3, there is no corresponding portion in the source code illustrated in FIG. 2, and the static analysis rule 1110 and the information propagation estimation rule 120 may apply in the program 101 including a source code different from the source code illustrated in FIG. 2 and the program 102 including a source code different from the source code illustrated in FIG. 3.

In the case of the item number 2 illustrated in FIG. 4, the static analysis unit 111 identifies (extracts) a socket file path to be substituted into the offset X (.sun_path) of the second argument of “connect” in which the first argument of “send” that is the information transmission function 1011 (or the information transmission function 1021) is the first argument. The static analysis unit 111 identifies the socket file path to be substituted into the offset X (.sun_path) of the second argument of “bind” having, as the first argument, the first argument of “accept” that outputs the first argument of “recv” that is the information reception function 1022 (or the information reception function 1012). Then, in a case where the socket file paths are matched on the transmission side and the reception side, the estimation unit 12 estimates that the information propagates from “send” that is the information transmission function 1011 (or the information transmission function 1021) to “recv” that is the information reception function 1022 (or the information reception function 1012).

In the case of the item number 3 illustrated in FIG. 4, the static analysis unit 111 identifies (extracts) a file path to be substituted into a first argument of “ftok” having, as a return value, a first argument of “shmget” having, as a return value, a first argument of “shmat” that is the information transmission function 1011 (or the information transmission function 1021) and an ID to be substituted into a second argument. At this point, the static analysis unit 111 determines that “shmat” is the transmission side because “IPC_CREAT” is designated in a third argument of “shmget”. The static analysis unit 111 identifies (extracts) the file path to be substituted into the first argument of “ftok” having, as the return value, the first argument of “shmget” having, as the return value, the first argument of “shmat” that is the information reception function 1022 (or the information reception function 1012) and the ID to be substituted into the second argument. At this point, the static analysis unit 111 determines that “shmat” is the reception side because “IPC_CREAT” is not designated in the third argument of “shmget”. Then, in a case where the file path and the ID match with each other on the transmission side and the reception side, the estimation unit 12 estimates that the information propagates from “shmat” that is the information transmission function 1011 (or the information transmission function 1021) to “shmat” that is the information reception function 1022 (or the information reception function 1012).

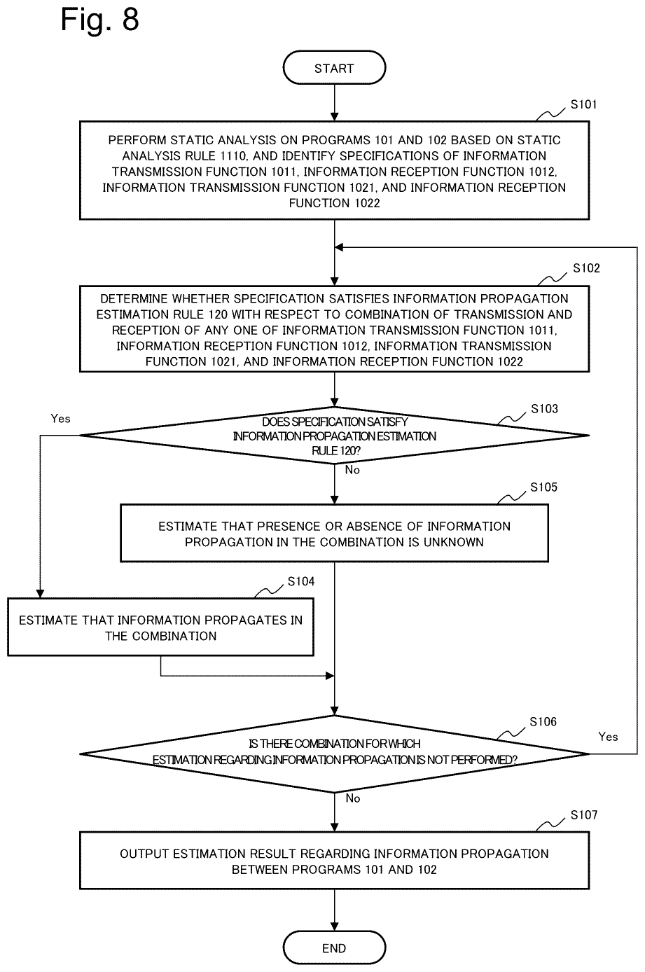

Next, estimation operation (processing) of information propagation across the program by static analysis of the program analysis device 10 according to the present example embodiment will be described in detail with reference to a flowchart of FIG. 8.

The static analysis unit 111 of the identification unit 11 performs static analysis on the programs 101 and 102 based on the static analysis rule 1110, and identifies the specifications of the information transmission function 1011, the information reception function 1012, the information transmission function 1021, and the information reception function 1022 (step S101). The estimation unit 12 determines whether the specification identified by the static analysis unit 111 satisfies the information propagation estimation rule 120 with respect to a combination of transmission and reception across any program of the information transmission function 1011, the information reception function 1012, the information transmission function 1021, and the information reception function 1022 (step S102).

When the specification satisfies the information propagation estimation rule 120 (Yes in step S103), the estimation unit 12 estimates that the information propagates across the program in the combination (step S104). When the specification does not satisfy the information propagation estimation rule 120 (No in step S103), the estimation unit 12 estimates that the presence or absence of information propagation across the program is unclear in the combination (step S105).

If there is the combination of transmission and reception across the program for which estimation regarding information propagation has not yet been performed (Yes in step S106), the processing returns to step S102. When there is no combination of transmission and reception across a program for which estimation regarding information propagation has not yet been performed (No in step S106), the estimation unit 12 outputs an estimation result regarding information propagation between the programs 101 and 102 (step S107), and the entire processing ends.

### Estimation Operation of Information Propagation Across Program By Dynamic Analysis On Program

The program analysis device 10 performs dynamic analysis on the operation of the program execution device 20 that executes both (for example, simultaneously) the program 101 and the program 102, thereby estimating the presence of information propagation from the program 101 to the program 102 or from the program 102 to the program 101. At this time, the program execution device 20 executes the programs 101 and 102 according to the dynamic analysis test scenario 110 given from the program analysis device 10. The dynamic analysis test scenario 110 is created by a user of the program analysis device 10, for example, and includes data provided to the programs 101 and 102, data representing execution environments of the programs 101 and 102, and the like. The dynamic analysis test scenario 110 is created so that information propagation occurring between the programs 101 and 102 can be detected as thoroughly as possible.

A dynamic analysis unit 112 included in the identification unit 11 identifies the transmission function for information to the outside included in the programs 101 and 102 (first program) and the reception function for information from the outside included in the programs 101 and 102 (second program) by performing dynamic analysis on information indicating the execution status of the program by the program execution device 20. More specifically, the dynamic analysis unit 112 performs dynamic analysis on information indicating a time series of instructions (functions and the like) executed by the program execution device that simultaneously executes the programs 101 and 102, thereby identifying specifications of the executed information transmission function 1011, information reception function 1012, information transmission function 1021, and information reception function 1022 based on the dynamic analysis rule 1120. The information indicating the execution status of the program by the program execution device 20 can be acquired by an existing API (Application Programming Interface) or the like that traces the execution status of the program (execution history of functions in the order of execution, and the like) for each step.

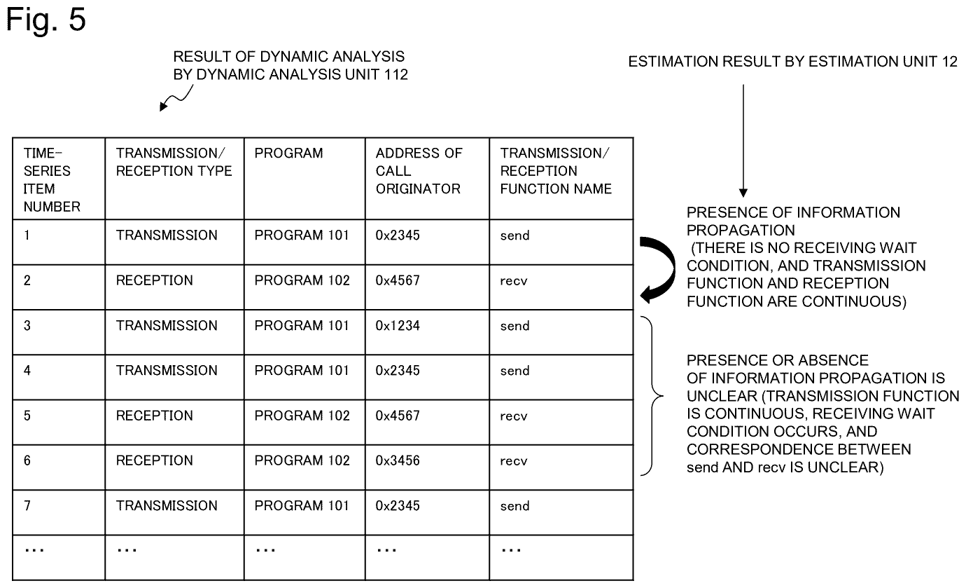

FIG. 5 is a diagram illustrating a first example of dynamic analysis by the dynamic analysis unit 112 according to the present example embodiment and the operation of the estimation unit 12 based on the result of the dynamic analysis.

The dynamic analysis unit 112 acquires the information indicating the execution status of the program by the program execution device 20 described above, and identifies (extracts) the specifications of the information transmission function 1011, the information reception function 1012, the information transmission function 1021, and the information reception function 1022 from the information based on the dynamic analysis rule 1120. As illustrated in FIG. 5, the dynamic analysis unit 112 identifies the type of transmission/reception, a program including the information transmission function or the information reception function, an address of a call originator of the information transmission function or the information reception function, and the name of the information transmission function or the information reception function in the order of time series in which the information transmission function or the information reception function is executed from the information indicating the execution status of the program. The dynamic analysis rule 1120 includes a list of names and the like related to the information transmission function or the information reception function, and indicates that the above-described items are extracted from the information indicating the execution status of the program. Among the above-described items, the address of the call originator is necessary to distinguish a plurality of information transmission functions or information reception functions of the same type included in the program. The dynamic analysis rule 1120 may indicate that an item different from the above-described item is extracted from the information indicating the execution status of the program.

The estimation unit 12 estimates the presence of information propagation between the programs 101 and 102 based on the analysis result by the dynamic analysis unit 112 and the information propagation estimation rule 120. In a case where the information transmission function and the information reception function are continuously executed without a receiving wait condition, the information propagation estimation rule 120 indicates that the information propagates between the information transmission function and the information reception function. However, the “receiving wait condition” represents a state in which the information reception function associated with the information transmission function (receiving the information transmitted from the information transmission function) is not executed after the information transmission function is executed.

According to the result of the dynamic analysis by the dynamic analysis unit 112 illustrated in FIG. 5, “recv” that is the information reception function 1022 of the program 102 according to a time-series item number 2 is executed next to “send” that is the information transmission function 1011 of the program 101 according to a time-series item number 1. In this case, regarding “send” of the time-series item number 1 and “recv” of the time-series item number 2, there is no receiving wait condition, and the information transmission function and the information reception function are continuous. Therefore, the estimation unit 12 estimates that the information propagates from “send” in the program 101 of the time-series item number 1 to “recv” in the program 102 of the time-series item number 2 according to the information propagation estimation rule 120.

According to the result of the dynamic analysis by the dynamic analysis unit 112 illustrated in FIG. 5, “send” that is the information transmission function 1011 of the program 101 according to a time-series item number 4 is executed next to “send” that is the information transmission function 1011 of the program 101 according to a time-series item number 3. Thereafter, “recv” that is the information reception function 1022 of the program 101 according to the time-series item number 4 is executed next to “recv” that is the information reception function 1022 of the program 102 according to a time-series item number 5. In this case, since the information transmission function 1011 is continuously executed and the above-described receiving wait condition occurs, the estimation unit 12 estimates, according to the information propagation estimation rule 120, that the presence or absence of information propagation is unknown for the information transmission function 1011 and the information reception function 1022 related to the time-series item numbers 3 to 6.

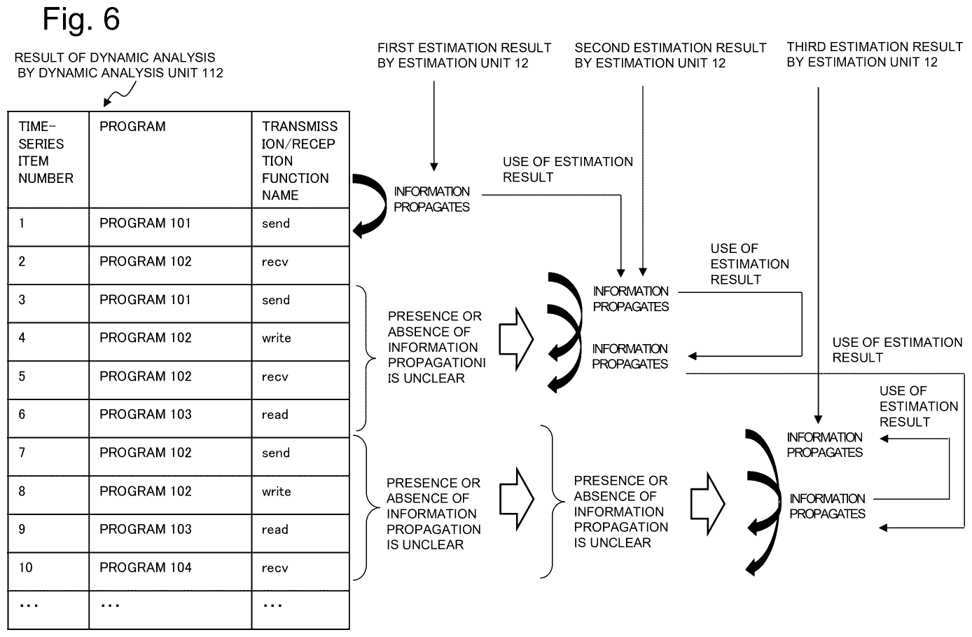

FIG. 6 is a diagram illustrating a second example of dynamic analysis by the dynamic analysis unit 112 according to the present example embodiment and the operation of the estimation unit 12 based on the result of the dynamic analysis. FIG. 6 illustrates an example in which the estimation unit 12 repeatedly estimates a new combination of the information transmission function and the information reception function through which the information propagates by using a combination of the information transmission function and the information reception function through which information propagation between programs has been estimated.

In the example illustrated in FIG. 6, similarly to the example of FIG. 5, in a first estimation operation, the estimation unit 12 estimates that the information propagates from “send” in the program 101 of the time-series item number 1 to “recv” in the program 102 of the time-series item number 2 according to the information propagation estimation rule 120. The estimation unit 12 also estimates that the presence or absence of information propagation is unknown because the receiving wait condition occurs for the information transmission function 1011 and the information reception function 1022 related to the time-series item numbers 3 to 6. The estimation unit 12 estimates that the presence or absence of information propagation is unknown because the receiving wait condition occurs for the information transmission function 1011 and the information reception function 1022 related to the time-series item numbers 7 to 10.

In a second estimation operation, the estimation unit 12 uses the fact that a combination of “send” of the time-series item number 1 and “recv” of the time-series item number 2, which are indicated by the first estimation result, is a combination in which the information propagates, to estimate that information propagates between “send” in the program 101 of the time-series item number 3 and “recv” in the program 102 of the time-series item number 5. Then, the estimation unit 12 estimates that there is a correspondence between the time-series item number 4 and the time-series item number 6 left in the time-series item numbers 3 to 6 by using the fact that a combination of “send” of the time-series item number 3 and “recv” of the time-series item number 5 is a combination through which the information propagates. That is, the estimation unit 12 estimates that the information propagates from “write” in the program 102 of the time-series item number 4 to “read” in the program 103 of the time-series item number 6.

In a third estimation operation, the estimation unit 12 uses the fact that a combination of “write” of the time-series item number 4 and “read” of the time-series item number 6, which are indicated by the second estimation result, is a combination in which the information propagates, to estimate that information propagates between “write” in the program 102 of the time-series item number 8 and “read” in the program 103 of the time-series item number 9. Then, the estimation unit 12 estimates that there is a correspondence between the time-series item number 7 and the time-series item number 10 left in the time-series item numbers 7 to 10 by using the fact that a combination of “write” of the time-series item number 8 and “read” of the time-series item number 9 is a combination through which the information propagates. That is, the estimation unit 12 estimates that the information propagates from “send” in the program 102 of the time-series item number 7 to “recv” in the program 104 of the time-series item number 10.

In the example illustrated in FIG. 6, the estimation unit 12 estimates that the information propagates in the combination of the information transmission function and the information reception function of any one of the time-series item numbers 1 to 10 by performing the above-described three estimation operations.

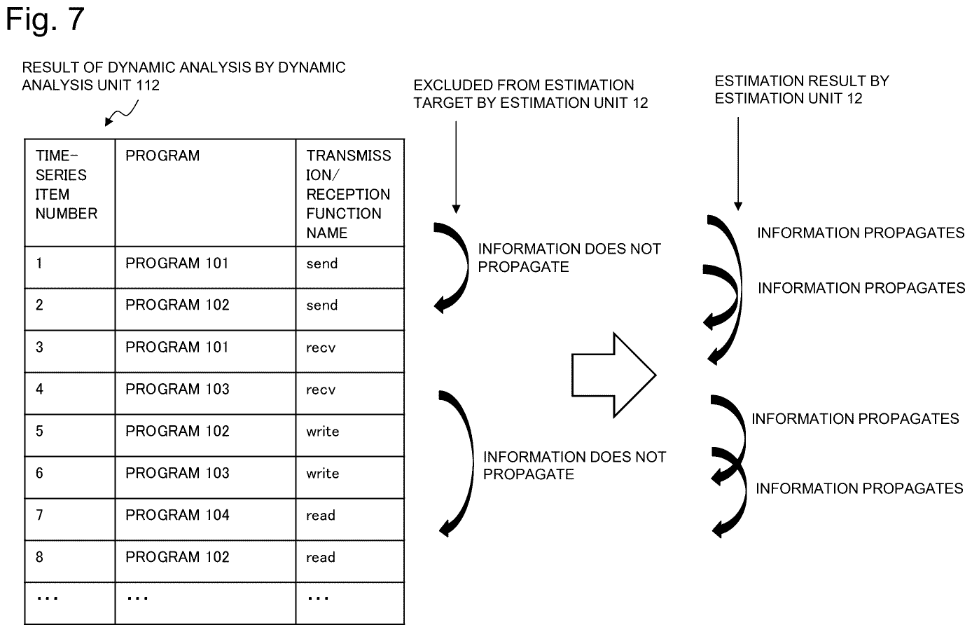

FIG. 7 is a diagram illustrating a third example of dynamic analysis by the dynamic analysis unit 112 according to the present example embodiment and the operation of the estimation unit 12 based on the result of the dynamic analysis. FIG. 7 illustrates an example in which the estimation unit 12 excludes information propagation between the information transmission function and the information reception function in the same program based on such a characteristic that, in general, there are few cases where the same program receives information transmitted from a certain program.

In the example illustrated in FIG. 7, first, according to the information propagation estimation rule 120, the estimation unit 12 estimates that the presence or absence of information propagation is unknown because the receiving wait condition occurs for the information transmission function and the information reception function related to the time-series item numbers 1 to 4. The estimation unit 12 estimates that the presence or absence of information propagation is unknown because the receiving wait condition occurs for the information transmission function and the information reception function related to the time-series item numbers 5 to 8.

Next, the estimation unit 12 excludes the information propagation from “send” in the program 101 of the time-series item number 1 to “recv” in the program 101 of the time-series item number 3. Similarly, the estimation unit 12 excludes the information propagation from “write” in the program 102 of the time-series item number 5 to “read” in the program 102 of the time-series item number 8.

Then, the estimation unit 12 estimates, as the transmission destination of the information, “recv” of the time-series item number 4 that is not excluded as the transmission destination of the information of “send” of the time-series item number 1, of “recv” of the time-series item number 3 and “recv” of the time-series item number 4 that are candidates for the transmission destination of the information of “send” of the time-series item number 1. In the time-series item numbers 1 to 4, the estimation unit 12 estimates that the information propagates between “send” in the remaining program 102 of the time-series item number 2 and “recv” in the program 101 of the time-series item number 3.

Similarly, the estimation unit 12 estimates, as the transmission destination of the information, “read” of the time-series item number 7 that is not excluded as the transmission destination of the information of “write” of the time-series item number 5, of “read” of the time-series item number 7 and “read” of the time-series item number 8 that are candidates for the transmission destination of the information of “write” of the time-series item number 5. In the time-series item numbers 1 to 4, the estimation unit 12 estimates that the information propagates between “write” in the remaining program 103 of the time-series item number 6 and “read” in the program 102 of the time-series item number 8.

In the example illustrated in FIG. 7, the estimation unit 12 estimates that the information propagates in the combination of the information transmission function and the information reception function of any one of the time-series item numbers 1 to 8 by excluding the information propagation between the information transmission function and the information reception function in the same program described above.

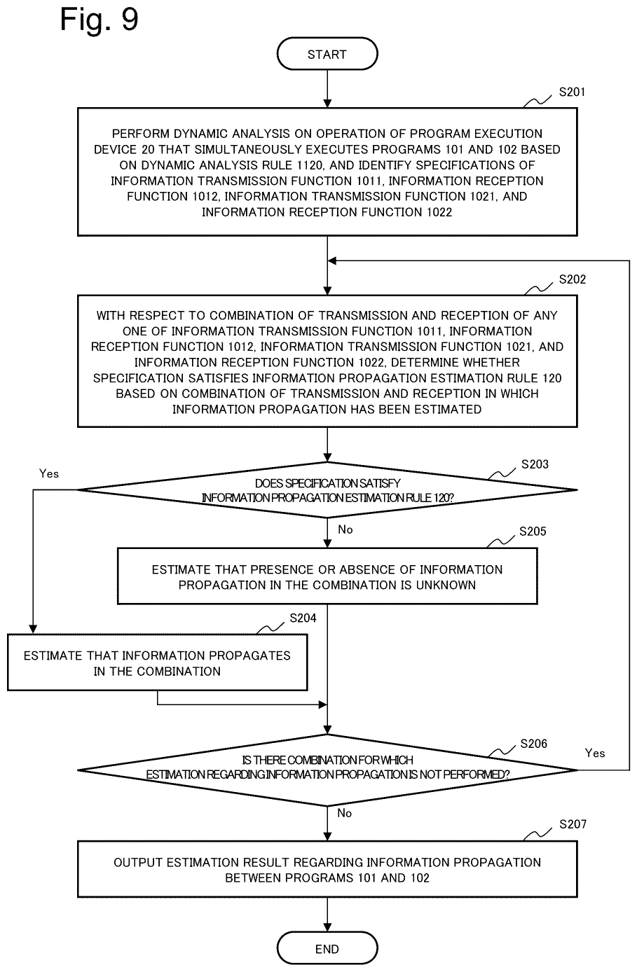

Next, estimation operation (processing) of information propagation across the program by dynamic analysis of the program analysis device 10 according to the present example embodiment will be described in detail with reference to a flowchart of FIG. 9.

The dynamic analysis unit 112 of the identification unit 11 performs dynamic analysis on the operation of the program execution device 20 that simultaneously executes the programs 101 and 102 based on the dynamic analysis rule 1120, and identifies the specifications of the information transmission function 1011, the information reception function 1012, the information transmission function 1021, and the information reception function 1022 (step S201). With respect to a combination of transmission and reception of any one of the information transmission function 1011, the information reception function 1012, the information transmission function 1021, and the information reception function 1022, the estimation unit 12 determines whether the specification satisfies the information propagation estimation rule 120 based on a combination of transmission and reception in which information propagation has been estimated (step S202).

When the specification satisfies the information propagation estimation rule 120 (Yes in step S203), the estimation unit 12 estimates that the information propagates across the program in the combination (step S204). When the specification does not satisfy the information propagation estimation rule 120 (No in step S203), the estimation unit 12 estimates that the presence or absence of information propagation across the program is unclear in the combination (step S205).

If there is the combination of transmission and reception across the program for which estimation regarding information propagation has not yet been performed (Yes in step S206), the processing returns to step S202. When there is no combination of transmission and reception across the program for which estimation regarding information propagation has not yet been performed (No in step S206), the estimation unit 12 outputs the estimation result regarding information propagation between the programs 101 and 102 (step S207), and the entire processing ends.

The program analysis device 10 according to the present example embodiment can track information propagation even in a case where the information propagates across a program. The reason is that the program analysis device 10 identifies the transmission function and the reception function for the information included in the programs 101 and 102 by at least one of the static analysis and the dynamic analysis on the programs 101 and 102, and estimates that the information propagates between the transmission function and the reception function in which the identification result satisfies the information propagation estimation rule 120.

Hereinafter, effects achieved by the program analysis device 10 according to the present example embodiment will be described in detail.

An illegal function of a malicious program executes processing outside the authority by using information that is input from the outside and known only by an attacker. In such detection of the illegal function, for example, a method of tracking a flow in which information input from the outside propagates from a variable to another variable by analyzing a control structure of a program is used. In such a method for detecting the illegal function, since analysis is usually performed in a program, there is a problem that, in tracking of propagation of information input from the outside, when the information reaches an information transmission function that transmits information to another program, subsequent information propagation cannot be tracked.

In response to such a problem, the program analysis device 10 according to the present example embodiment performs at least one of, for example, static analysis for the programs 101 and 102 and dynamic analysis for the operation of the program execution device 20 that executes both the programs 101 and 102. The program analysis device 10 identifies the information transmission function 1011 included in the program 101 and the information reception function 1022 included in the program 102 by the static analysis and the dynamic analysis. Then, the program analysis device 10 estimates that the information propagates between the information transmission function 1011 and the information reception function in which the specification indicated by the identification result regarding the information transmission function 1011 and the information reception function 1022 satisfies the information propagation estimation rule 120. Therefore, the program analysis device 10 can track information propagation even in a case where the information propagates across a program.

As illustrated in FIG. 6, the program analysis device 10 according to the present example embodiment repeatedly estimates a new combination of the information transmission function and the information reception function through which the information propagates by using a combination of the information transmission function and the information reception function through which information propagation has been estimated. As a result, the program analysis device 10 can more comprehensively detect the combination of the information transmission function and the information reception function through which the information propagates.

The program analysis device 10 according to the present example embodiment uses, as the information propagation estimation rule 120, excluding information propagation between the information transmission function and the information reception function in the same program. As a result, the program analysis device 10 can more comprehensively detect the combination of the information transmission function and the information reception function through which the information propagates.

The program analysis device 10 according to the present example embodiment performs at least one of the static analysis and the dynamic analysis on the programs 101 and 102, and can more comprehensively track information propagation across the program by performing both the static analysis and the dynamic analysis and complementing the analysis results with each other.

For example, in the program 101 illustrated in FIG. 2 and the program 102 illustrated in FIG. 3, when there is no information for identifying a communication partner in the program (for example, the communication partner is set by a configuration file or through a program), it is difficult to identify the combination of the information transmission function and the information reception function through which the information propagates by static analysis. Therefore, the program analysis device 10 may identify the combination of the information transmission function and the information reception function, which are difficult to identify by the static analysis as described above, by the dynamic analysis.

On the other hand, on the contrary, it may be difficult to identify the combination of the information transmission function and the information reception function, through which the information propagates, by the dynamic analysis depending on a shortage of the test scenario in the dynamic analysis and a problem of the timing at which the information transmission function and the information reception function are executed. Therefore, the program analysis device 10 may identify the combination of the information transmission function and the information reception function, which are difficult to identify by the dynamic analysis as described above, by the static analysis.

The program analysis device 10 according to the present example embodiment may perform estimation regarding information propagation based on the result of dynamic analysis by the identification unit 11 by using the estimation result by the estimation unit 12 regarding information propagation based on the result of static analysis by the identification unit 11. That is, for example, the program analysis device 10 may reflect the estimation result obtained in the static analysis on the dynamic analysis test scenario 110 to perform the dynamic analysis. As a result, the program analysis device 10 can more efficiently track information propagation across a program.

### Second Example Embodiment

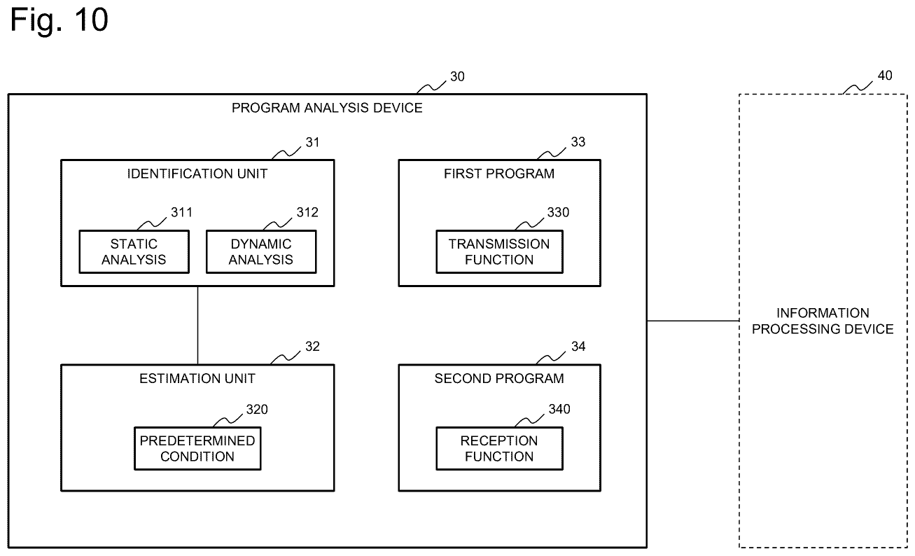

FIG. 10 is a block diagram illustrating a configuration of a program analysis device 30 according to a second example embodiment of the present invention. The program analysis device 30 includes an identification unit 31 and an estimation unit 32. However, the identification unit 31 and the estimation unit 32 are examples of identification means and estimation means in order.

The identification unit 31 identifies a transmission function 330 for information included in a first program 33 and a reception function 340 for information included in a second program 34 by performing at least one of static analysis 311 for the first program 33 and the second program 34 and dynamic analysis 312 for an operation of an information processing device 40 that executes both the first program 33 and the second program 34. The first program 33 is, for example, a program similar to the program 101 or 102 according to the first example embodiment. The second program 34 is, for example, a program similar to the program 101 or 102 according to the first example embodiment. The transmission function 330 is, for example, a function similar to the information transmission function 1011 or the information transmission function 1021 according to the first example embodiment. The reception function 340 is, for example, a function similar to the information reception function 1012 or the information reception function 1022 according to the first example embodiment. The static analysis 311 is, for example, an analysis similar to the analysis performed by the static analysis unit 111 according to the first example embodiment. The dynamic analysis 312 is, for example, an analysis similar to the analysis performed by the dynamic analysis unit 112 according to the first example embodiment. The identification unit 31 operates similarly to the identification unit 11 according to the first example embodiment, for example.

The estimation unit 32 estimates that the information propagates between the transmission function 330 and the reception function 340 in which the specification indicated by the identification result regarding the transmission function 330 and the reception function 340 satisfies a predetermined condition 320. The predetermined condition 320 is, for example, a condition similar to that of the information propagation estimation rule 120 according to the first example embodiment. The estimation unit 32 operates similarly to the estimation unit 12 according to the first example embodiment, for example.

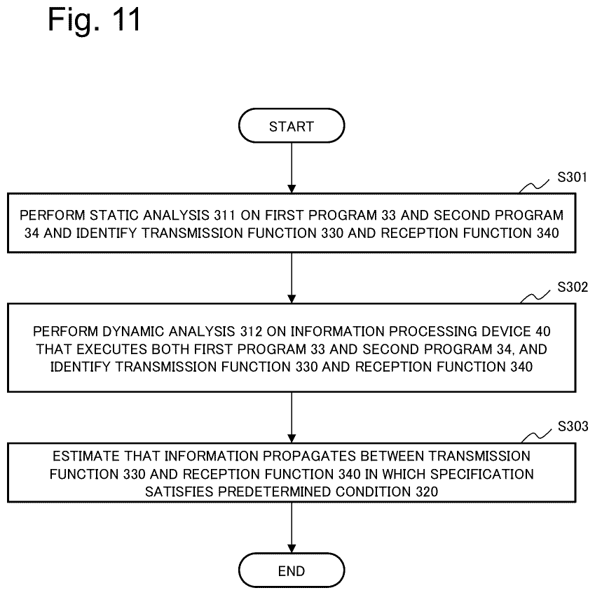

Next, operation (processing) of the program analysis device 30 according to the present example embodiment will be described in detail with reference to a flowchart of FIG. 11.

The identification unit 31 performs the static analysis 311 on the first program 33 and the second program 34, and identifies the transmission function 330 and the reception function 340 (step S301). The identification unit 31 performs the dynamic analysis 312 on the information processing device 40 that executes both the first program 33 and the second program 34, and identifies the transmission function 330 and the reception function 340 (step S302). The estimation unit 32 estimates that the information propagates between the transmission function 330 and the reception function 340 in which the specification satisfies a predetermined condition 320 (step S303), and the entire processing ends.

The program analysis device 30 according to the present example embodiment can track information propagation even in a case where the information propagates across a program. The reason is that the program analysis device 30 identifies the transmission function 330 and the reception function 340 for the information included in the first program 33 and the second program 34 by at least one of the static analysis and the dynamic analysis on the first program 33 and the second program 34, and estimates that the information propagates between the transmission function 330 and the reception function 340 in which the identification result satisfies the predetermined condition 320.

### Hardware Configuration Example

Each unit in the program analysis device 10 illustrated in FIG. 1 or the program analysis device 30 illustrated in FIG. 10 in each of the above-described example embodiments can be achieved by dedicated HW (Hard Ware) (electronic circuit). In FIGS. 1 and 10, at least the following configuration can be regarded as a function (processing) unit (software module) of a software program.
Identification units 11 and 31,
static analysis unit 111,
dynamic analysis unit 112,
estimation units 12 and 32, and
storage control function in storage unit 13.

However, the division of each unit illustrated in these drawings is a configuration for convenience of description, and various configurations can be assumed at the time of implementation. An example of a hardware environment in this case will be described with reference to FIG. 12.

FIG. 12 is a diagram exemplarily describing a configuration of an information processing device 900 (computer system) capable of realizing the information processing device included in the program analysis device 10 according to the first example embodiment or the program analysis device 30 according to the second example embodiment of the present invention. That is, FIG. 12 illustrates a configuration of at least one computer (information processing device) capable of realizing the system illustrated in FIGS. 1 and 10, and illustrates a hardware environment capable of realizing each function in the above-described example embodiment.

The information processing device 900 illustrated in FIG. 12 includes the following components, and may not include some of the following components.
CPU (Central_Processing_Unit) 901,
ROM (Read_Only_Memory) 902,
RAM (Random_Access_Memory) 903,
hard disk (storage device) 904,
communication interface 905 with external device,
bus 906 (communication line),
reader/writer 908 capable of reading and writing data stored in recording medium 907 such as CD-ROM (Compact_Disc_Read_Only_Memory), and
input/output interface 909 such as monitor, speaker, or keyboard.

That is, the information processing device 900 including the above-described components is a general computer to which these components are connected via the bus 906. The information processing device 900 may include a plurality of the CPUs 901 or may include a CPU901 configured by multiple cores. The information processing device 900 may include a GPU (Graphical_Processing_Unit) (not illustrated) in addition to the CPU 901.

In the present invention described using the above-described example embodiment as an example, a computer program capable of realizing the following functions is supplied to the information processing device 900 illustrated in FIG. 12. The function is the above-described configuration in the block configuration diagram (FIGS. 1 and 10) referred to in the description of the example embodiment or the function of the flowchart (FIGS. 8, 9, and 11). Thereafter, the present invention is achieved by reading the computer program to the CPU 901 of the hardware and interpreting and executing the computer program. The computer program supplied into the apparatus may be stored in a readable/writable volatile memory (RAM 903) or a nonvolatile storage device such as the ROM 902 or the hard disk 904.

In the above case, a general procedure can be adopted at present as a method of supplying the computer program into the hardware. Examples of the procedure include a method of installing the program in the apparatus via various recording media 907 such as a CD-ROM, a method of downloading the program from the outside via a communication line such as the Internet, and the like. In such a case, the present invention can be understood to be constituted by a code constituting the computer program or the recording medium 907 storing the code.

The present invention has been described above using the above-described example embodiments as exemplary examples. However, the present invention is not limited to example embodiments thereof. That is, various aspects that can be understood by those skilled in the art can be applied to the present invention without departing from the spirit and scope of the present invention as defined by the claims.

### Reference Signs List

1 program analysis system
10 program analysis device
11 identification unit
111 static analysis unit
1110 static analysis rule
112 dynamic analysis unit
1120 dynamic analysis rule
12 estimation unit
120 information propagation estimation rule
13 storage unit
101 program
1011 information transmission function
1012 information reception function
102 program
1021 information transmission function
1022 information reception function
110 dynamic analysis test scenario
20 program execution device
30 program analysis device
31 identification unit
311 static analysis
312 dynamic analysis
32 estimation unit
320 predetermined condition
33 first program
330 transmission function
34 second program
340 reception function
40 information processing device
900 information processing device
901 CPU
902 ROM
903 RAM
904 hard disk (storage device)
905 communication interface
906 bus
907 recording medium
908 reader/writer
909 input/output interface

What is claimed is:

1. A program analysis device comprising:
at least one memory storing instructions; and
at least one processor configured to execute the instructions to:
identify a transmission function for information included in a first program and a reception function for information included in a second program by performing at least one of static analysis on the first program and the second program and dynamic analysis on an operation of an information processing device that executes both of the first program and the second program; and
estimate that the information propagates between the transmission function and the reception function, for which a specification indicated by an identification result regarding the transmission function and the reception function satisfies a predetermined condition.

2. The program analysis device according to claim 1, wherein the at least one processor is further configured to execute the instructions to:
identify a specification of an information transmission function representing the transmission function and a specification of an information reception function representing the reception function in the static analysis, and
estimate that the information propagates between the transmission function and the reception function in a case where the predetermined condition is satisfied, using, as the predetermined condition, matching between a port of a transmission destination of information by the information transmission function and a port of a reception destination of information by the information reception function.

3. The program analysis device according to claim 2, wherein the at least one processor is further configured to execute the instructions to:
estimate that the information propagates between the transmission function and the reception function in a case where the predetermined condition is satisfied, using, as the predetermined condition, matching between an address of a transmission destination of the information by the information transmission function and an address of a reception destination of the information by the information reception function.

4. The program analysis device according to claim 1, wherein the at least one processor is further configured to execute the instructions to:
identify an information transmission function representing the transmission function and an information reception function representing the reception function in the static analysis, and
estimate that the information propagates between the transmission function and the reception function in a case where the predetermined condition is satisfied, using, as the predetermined condition, matching between a socket file path related to the information transmission function and a socket file path related to the information reception function.

5. The program analysis device according to claim 1, wherein the at least one processor is further configured to execute the instructions to:
acquire in the dynamic analysis, a transmission status of information due to execution of an information transmission function representing the transmission function and a reception status of information due to execution of an information reception function representing the reception function; and
estimate that the information propagates between the transmission function and the reception function in a case where the predetermined condition is satisfied, using, as the predetermined condition, one-to-one correspondence between the information transmission function indicated by the transmission status and the information reception function indicated by the reception status.

6. The program analysis device according to claim 5, wherein the at least one processor is further configured to execute the instructions to:
estimate repeatedly a new combination of the transmission function and the reception function through which information propagates by using a combination of the transmission function and the reception function through which information propagation has been estimated.

7. The program analysis device according to claim 5, wherein the at least one processor is further configured to execute the instructions to:
estimate that the information propagates between the transmission function and the reception function in a case where the predetermined condition is satisfied, using, as the predetermined condition, excluding information propagation between the information transmission function and the information reception function in the same program.

8. The program analysis device according to claim 1, wherein the at least one processor is further configured to execute the instructions to:
estimate information propagation based on a result of the dynamic analysis by using an estimation result regarding information propagation based on a result of the static analysis.

9. A program analysis method comprising, by a first information processing device:
identifying a transmission function for information included in a first program and a reception function for information included in a second program by performing at least one of static analysis on the first program and the second program and dynamic analysis on an operation of a second information processing device that executes both of the first program and the second program; and
estimating that the information propagates between the transmission function and the reception function, for which a specification indicated by an identification result regarding the transmission function and the reception function satisfies a predetermined condition.

10. A non-transitory recording medium storing a program analysis program for causing a computer to execute:
an identifying process of identifying a transmission function for information included in a first program and a reception function for information included in a second program by performing at least one of static analysis on the first program and the second program and dynamic analysis on an operation of an information processing device that executes both of the first program and the second program; and
an estimation process of estimating that the information propagates between the transmission function and the reception function, for which a specification indicated by an identification result regarding the transmission function and the reception function satisfies a predetermined condition.
